(19) United States
(12) Patent Application Publication
(10) Pub. No.: US 2020/0261817 A1
(43) Pub. Date: Aug. 20, 2020

(54) Novel Scale Model Remote Controlled Eighteen Wheeler Model Truck Entertainment System

(71) Applicant: Walter Edwards, Commack, NY (US)

(72) Inventor: Walter Edwards, Commack, NY (US)

(21) Appl. No.: 16/276,315

(22) Filed: Feb. 14, 2019

(51) Int. Cl. A63H 30/04; A63H 17/05; A63H 17/26; G05D 1/02

(52) U.S. Cl. CPC A63H 30/04; G05D 1/021; A63H 17/268; A63H 17/05

(57) ABSTRACT

The invention is remote controlled ¼ scale model eighteen wheeler truck which has an electrically powered cab, which has steam emissions to mimic exhaust, and has a built in stereo and storage compartment and flat screen in the trailer portion. The model can be moved under it's own power and when stopped, converts into an entertainment system by having a flat screen raised above the cab on an actuator track.

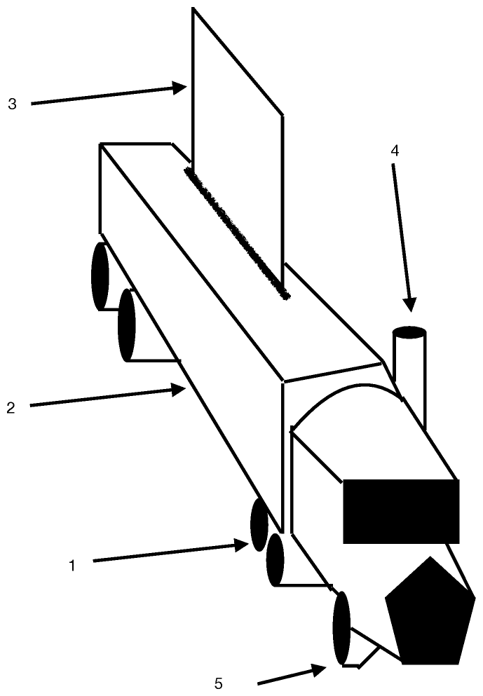

### FIELD OF THE INVENTION

The field of the invention is the field of remote-controlled toys.

### BACKGROUND OF THE INVENTION

The field of remote controlled scaled down toy vehicles is in the public domain to a large extent. Most of the innovation in the space revolves around innovations in the electronics used to control and communicate with the model. In addition, most models are dramatically scaled down in order to make the model easily handled by the end-user.

### BACKGROUND OF THE INVENTION

In U.S. Pat. No. 9,814,973, the inventor Barney describes an entertainment system which is interactive. The inventor describes a variety of feedback sounds and lights which enhance the user experience. In U.S. Pat. No. 5,435,768 Duleavy describes a scale model specifically of a trash truck. In this invention, actuators move portions of the truck and even open the doors and actuate the compactor. This is an attempt at making the model more realistic.

In another example, the inventor Myer in U.S. Pat. No. 5,295,890 describes a scale model remote controlled truck which can deliver a jet of water through a miniature water cannon.

### OBJECTS OF THE INVENTION

One object of the invention is to develop a new promotional device to project music and recordings towards crowds and audiences. Another object of the invention is to invent a new scale model truck which is remote controlled. Yet another object of the invention is to make a quarter-scale model which is remotely controlled. Another object of the invention is to develop a quarter scale model which is self-powered. Yet another object of the invention is to invent a self powered mobile entertainment system. Another object of the invention is to invention is to invent a one quarter scale self propelled model truck with a storage compartment built into the trailer portion of the model.

### SUMMARY OF THE INVENTION

The invention s a remote controlled self propelled model truck at one quarter scale which is remote controlled and has an incorporated stereo system and a storage compartment. The invention is self powered from electrical motors located in the cab portion of the truck model. It also has exhaust pipes which expel steam to mimic exhaust. From the trailer portion of the scale model, a flat screen is raised by actuators to serve as an entertainment screen.

### DETAILED DESCRIPTION OF THE INVENTION

A one quarter scale eighteen wheeler truck is fabricated from aluminum and scale down wheels and tires powered by electrical direct drive electrical motors. The cab is realistically constructed and the attached trailer contains both a full size stereo system and a forward storage compartments. The model vehicle is self powered by dc electrical motors and controlled by radio controlled remote control. The truck's use of electric motors gives it access to sidewalks and pathways.

### Examples of the Invention

(drawings detailed)

### DRAWINGS EXPLANATION 1/1

1) 45-HP DC motor powered remote controlled wheels.
2) Trailer pulled by cab with entertainment accessories.
3) Deployed digital screen or television.
4) Steam emitting exhaust pipe
5) Remote controlled directing wheels.

1. A quarter scale self powered model truck which is remotely controlled and carries a deployable flat screen in the trailer and a DJ music system in the trailer portion of the model.

2. The claim in 1 where steam outlets mimic exhaust from the models mufflers.

3. The claim in 1 where the trailer is constructed from wood to increase deployment range for the self powered model.
